(19) United States
(12) Patent Application Publication
(10) Pub. No.: US 2022/0371276 A1
(43) Pub. Date: Nov. 24, 2022

(54) BUILD UNIT PREPARATION

(71) Applicant: Hewlett-Packard Development Company, L.P., Spring, TX (US)

(72) Inventor: Heribert Farreny Agras, Sant Cugat del Valles (ES)

(73) Assignee: Hewlett-Packard Development Company, L.P., Spring, TX (US)

(21) Appl. No.: 17/773,336

(22) PCT Filed: Jan. 20, 2020
(86) PCT No.: PCT/US2020/014283

§ 371 Date: Apr. 29, 2022

(51) Int. Cl. B29C 64/295; B29C 64/393; B33Y 10/00; B33Y 30/00; B33Y 50/02

(52) U.S. Cl. CPC B29C 64/295; B29C 64/393; B33Y 10/00; B33Y 30/00; B33Y 50/02

(57) ABSTRACT

According to one aspect there is provided a method of preparing a build unit for use in a 3D printer. The method comprises receiving a build unit at an interface of a build unit preparation module and performing a predetermined build unit preparation process on the build unit.

### BACKGROUND

There exist a multitude of kinds of three-dimensional (3D) printing techniques that allow the generation of 3D objects through selective solidification of a build material based on a 3D object model.

Some 3D printing systems generate 3D objects in transportable build units that may be moved between different modules of a 3D printing system. For example, a build unit may be movable between a 3D printing and a powder processing station.

### BRIEF DESCRIPTION

Examples will now be described, by way of non-limiting example only, with reference to the accompanying drawings, in which:

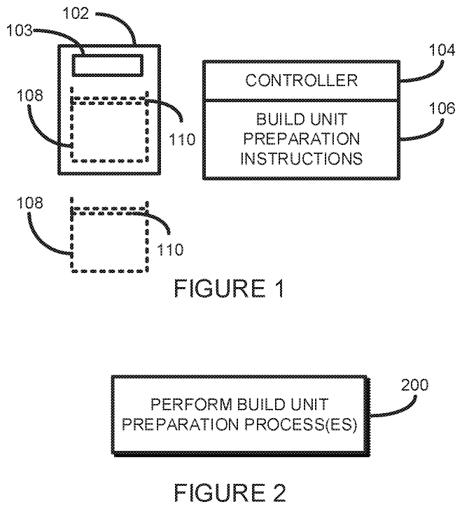

FIG. 1 is a schematic drawing of a build unit preparation module according to one example;

FIG. 2 is a flow diagram outlining a method of operating a build unit preparation module according to one example;

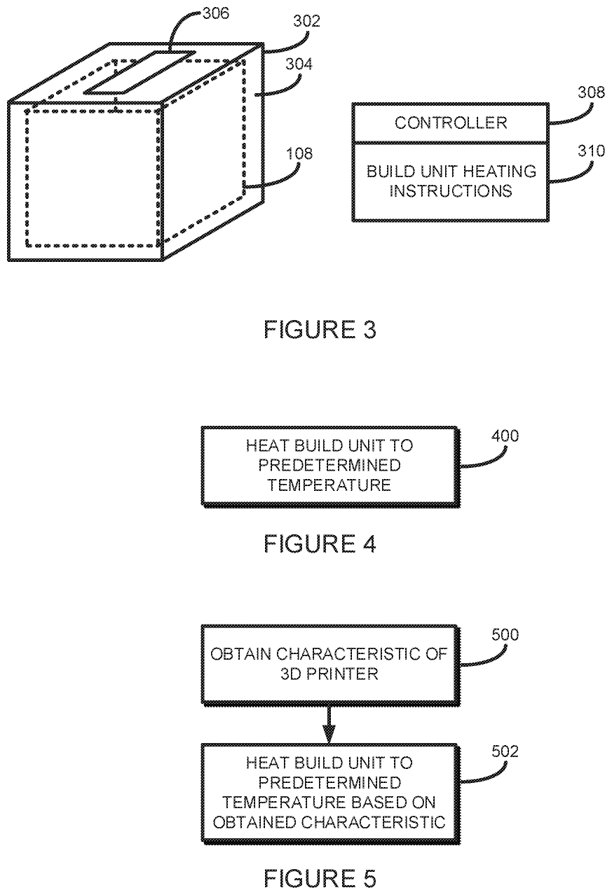

FIG. 3 is a schematic drawing of a build unit preparation module according to one example;

FIG. 4 is a flow diagram outlining a method of operating a build unit preparation module according to one example;

FIG. 5 is a flow diagram outlining a method of operating a build unit preparation module according to one example;

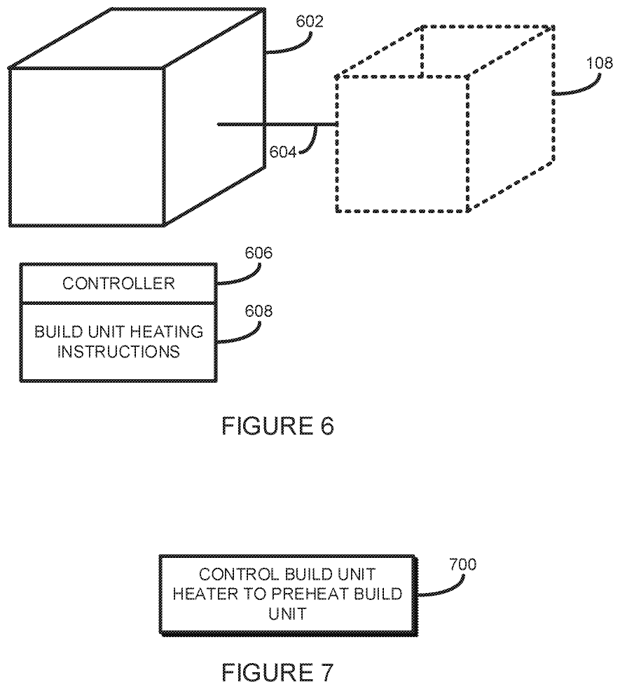

FIG. 6 is a schematic drawing of a build unit preparation module according to one example;

FIG. 7 is a flow diagram outlining a method of operating a build unit preparation module according to one example;

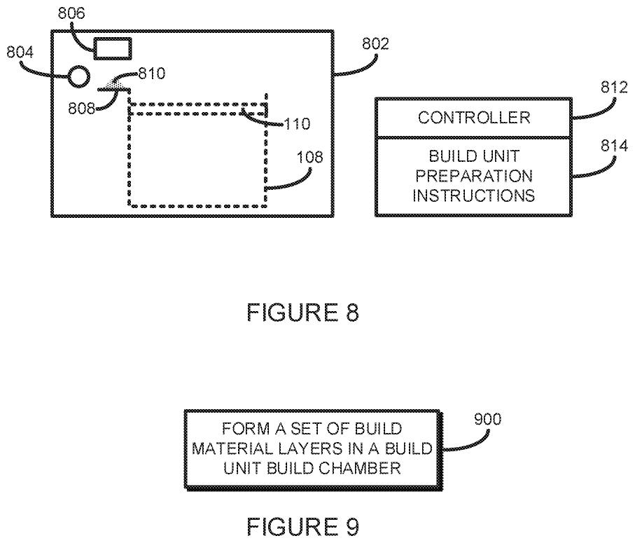

FIG. 8 is a schematic drawing of a build unit preparation module according to one example;

FIG. 9 is a flow diagram outlining a method of operating a build unit preparation module according to one example;

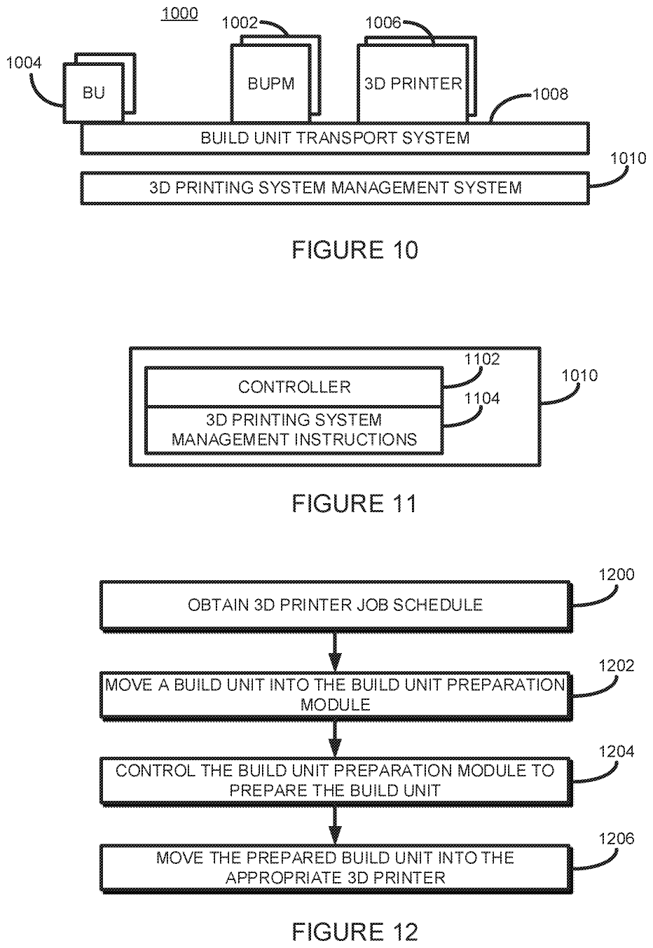

FIG. 10 is a schematic drawing of a 3D printing system according to one example;

FIG. 11 is a block diagram of a 3D printing system management system according to one example; and

FIG. 12 is a flow diagram outlining a method of operating a 3D printing system according to one example;

### DETAILED DESCRIPTION

Some three-dimensional (3D) printing systems form 3D objects by forming successive layers of a powdered or granular build material in a build chamber, and selectively solidifying portions of each layer to form the desired object on a layer-by-layer basis. Some such 3D printing technologies have now reached a stage where they are suitable for use in industrial applications, for example for the large-scale or mass production of 3D printed objects.

Powder-based 3D printing systems may generate 3D objects in transportable build units that may be moved between different modules of a 3D printing system. For example, a build unit may be movable between a 3D printer, that forms and selectively solidifies portions of each layer, and a separate powder processing station, that processes the contents of the build unit after printing to separate solidified 3D objects from non-solidified powder. A build unit typically provides a build chamber in which 3D objects may be generated by a 3D printer and a vertically moveable platform within the build chamber on which layers of a powdered or granular build material may be formed thereon. Portions of each formed layer may then be selectively solidified by the 3D printer to form layers of a 3D object. Examples of powdered build materials include plastic, metal, and ceramic build materials.

Before a 3D printer can start generating 3D objects it generally has to perform some preparatory process or processes on the build unit that is to be used by the printer once the build unit is coupled to the 3D printer. Preparatory processes may include, for example, heating the build unit to a predetermined temperature, and forming a number of initial layers of build material in the build unit build chamber. However, such preparatory processes take some time to perform and hence reduce the actual time that a 3D printer can spend generating 3D objects. Any improvements made to a 3D printing workflow may have a direct impact on the speed and efficiency of 3D printing systems.

Techniques described herein aim to improve the throughput of a 3D printing system by providing systems and associated methods to prepare a build unit outside of, or separately from, a 3D printer so that at least some of the build unit preparation is performed outside of a 3D printer. In this way, when a build unit is coupled to a 3D printer, the printer may start using the build unit to generate 3D printed objects more rapidly than if the preparation was performed by the printer itself. Furthermore, preparation of build units outside of a 3D printer enables improved printing throughput and efficiency, especially where multiple 3D printers are used.

Referring to FIG. 1, there is shown a schematic drawing of a build unit preparation module 102 according to one example. The build unit preparation module 102 is to receive or couple, for example through an appropriate interface, to a 3D printer build unit 108 having a movable build platform 110, illustrated with dotted lines. The build unit preparation module 102 comprises one or multiple build unit preparation elements 103, and a controller 104, such as a microprocessor 104, coupled to a memory (not shown) in which are stored build unit preparation instructions 106. The build unit preparation instructions 106 are machine-readable instructions that, when executed by the controller 104, cause the one or multiple build unit preparation elements 103 to perform build unit preparation operations on a build unit 108 received by or coupled to thereto, as illustrated at block 200 in the flow diagram shown in FIG. 2. In one example, the build unit preparation instructions 106 control the build unit preparation module 102 to complete the preparation process based on data indicating when a 3D printer is to use the prepared build unit. In this way, the build unit preparation module 102 may prepare the build unit such that a 3D printer may use the prepared build unit with little or no undue delay.

The nature of the build unit preparation module 102 and the build unit preparation instructions may vary depending on the type of preparation processes that are to be performed on the build unit. This may depend, for example, on the type of 3D printing system with which the build unit is to be used. Examples will now be described below.

Referring now to FIG. 3A, there is shown a schematic diagram of a build unit preparation module 302 according to one example. In this example, the build unit 108 is for use in a 3D printing system in which layers of a powder material such, such as a powdered polymer powder are formed in the build unit and in which portions of each formed layer are selectively solidified through the selective application or selective absorption of heat. For example, such a printing system may be a selective laser sintering system, may be a fusing agent and fusing energy type system, may be a metal binder jet system, or the like. Such systems may be sensitive to changes in temperature during a 3D printing process. Typically, to help reduce such temperature changes a 3D printer may pre-heat at least a portion of a build unit, such as the build chamber, once the build unit is inserted into the 3D printer before the 3D printer starts generating a 3D object. However, such a process may be relatively slow (for example it could take more than 30 minutes, or more than 1 hour), and hence may delay the start of actual 3D printing processes within a 3D printed.

In the example shown, the build unit preparation module 302 comprises a substantially closed or closable housing that forms an internal volume 304 which is to wholly receive the build unit 108, as illustrated in FIG. 3. In one example the build unit preparation module 302 comprises at least one moveable external wall (not shown), for example a hinged or sliding wall, to enable a build unit to be inserted thereinto and removed therefrom as appropriate. In one example the movable wall may be electromechanically controllable, for example using a motor or servo, to allow the build unit preparation module 302 to be opened and closed under control of a controller. In one example the build unit 108 may be only partial received within the internal volume 304. In another example, the build unit preparation module 302 comprises an open base, and the build unit preparation module 302 may be movable, for example using a suitable transportation system (not shown), to be lifted over the top of a build unit and then lowered over the build unit thereby to substantially enclose the build unit within the build unit preparation module 302.

The build unit preparation module 302 is provided with at least one heating element 306, such as a resistive heating element, an infra-red lamp, or equivalent. The heating element 306 is to heat up a build unit within the build unit preparation module 302 to a predetermined temperature. For example, the heating element 306 may directly heat a build unit 108, or the heating element 306 may indirectly heat build unit 108, for example by heating the air within the volume 304. The predetermined temperature may, for example, be a temperature at which a 3D printing system which is to subsequently use the heated build unit is expecting, such that the 3D printing system may start 3D printing processes using the build unit without having to heat the build unit itself, or with only having to minimally heat the build unit itself. In one example, the predetermined temperature may be between about 50 to 100 degrees Celsius, although in other examples other temperatures may be used. In this way, a 3D printing system which receives a pre-heated build unit may start performing 3D printing operations more rapidly than a 3D printing system that receives a non-preheated build unit.

The build unit preparation module 302 further comprises a controller 308 and build unit heating instructions 310 stored in a memory (not shown) coupled to the controller 308. The controller 308 executes the instructions 310 to control the build unit preparation module 302 to heat (block 400, shown in FIG. 4) a build unit inserted therein to a predetermined temperature.

In one example, the predetermined temperature may be modified based on a characteristic, for example, such as the type of 3D printer with which the build unit is to be used, or the type of build material to be used by the 3D printer. In this example, as shown in FIG. 5, the controller 308 may obtain (block 500) a characteristic of the 3D printer that is to use the build unit 108, and may then control (block 502) the build unit preparation module 302 to heat the build unit to a temperature based on the obtained characteristic.

Once the build unit 108 has been heated to the predetermined temperature the build unit preparation module 302 may maintain the build unit 108 at the predetermined temperature until such time that the build unit 108 is removed therefrom to be inserted into a 3D printer. In one example, the whole or substantially the whole of the build unit 108 is heated to the predetermined temperature. In another example, only a selection portion of the build unit 108, such as a build chamber, is heated to the predetermined temperature.

In one example, since the build unit preparation module 302 comprises the heating element 306, the build unit 108 may be designed not to comprise any heating elements. This may simplify the design of such build units and may help in reducing their cost.

In one example, a transport system is provided to move a build unit from a build unit parking zone into and out of the build unit preparation module 302 and to move a prepared build unit into and out of a 3D printer. Such a transport system may, for example, comprise a movable conveyor belt, a set of tracks or rails, or any other suitable transport system. In one example, the build unit is a powered and autonomously movable build unit, such that the build unit itself is capable of moving itself into and out of the build unit preparation module 302 and then into an out of a 3D printer.

Referring now to FIG. 6, there is shown a schematic diagram of a build unit preparation module 602 according to another example. In this example, the build unit 108 is provided with one or multiple heating elements (not shown) that are to preheat at least a portion of the build unit 108 to a predetermined temperature. In one example, the one or multiple heating elements are to preheat at least a build chamber of the build unit 108. Accordingly, the build unit preparation module 602 comprises an electrical coupling 604 to electrically couple to the one or multiple heating elements of the build unit 108. In this way, a build unit may be coupled to the build unit preparation module 602 which supplies electric power to the build unit 108 to cause at least a portion of the build unit 108 to be preheated to a predetermined temperature.

The build unit preparation module 602 further comprises a controller 606 having build unit heating instructions 608 stored in a memory coupled to the controller. The controller executes the instructions 608 to control the build unit preparation module 602 to heat (block 700, shown in FIG. 7) a build unit coupled thereto to a predetermined temperature.

Once the build unit 108 has been heated to the predetermined temperature the build unit preparation module 602 may maintain the predetermined temperature until such time that the build unit 108 is decoupled therefrom to be inserted into a 3D printer.

Referring now to FIG. 8, there is shown a schematic diagram of a build unit preparation module 802 according to a further example. The build unit preparation module 802 comprises a layering device 804, such as a translatable roller or a wiper, a storage container 806 to contain a supply of build material, and a build material spreading platform 808. The layering device 804 is to form layers of build material on a build platform 110 of a build unit 108 when a build unit inserted into build unit preparation module 802, for example by spreading a volume of build material 810 formed on the build material spreading platform 808 across the build platform 110. In other examples other layer forming techniques could be used, for example directly providing build material onto the build platform from an overhead hopper.

The build unit preparation module 802 further comprises a controller 812 having build unit preparation instructions 814 stored in a memory (not shown) coupled to the controller. The controller 812 executes the instructions 814 to control the build unit preparation module 802 to form (block 900, shown in FIG. 9) a set of layers of build material layers heat on a build platform of a build unit inserted. For example, the controller 802 may control the layering device 804 to spread a layer of build material formed on the build material spreading platform 808 on the surface of the build platform, or on a previously formed layer of build material. The controller 802 may also control the height of the build unit build platform, to allow the platform to be lowered by a predetermined distance to enable each layer of build material to be successively formed thereon. In one example, the set of layers may comprise a set of between 1 and 50 layers of build material. This set of layers may, for example, to ensure that the build unit 108 has a suitable number of blank layers of build material formed therein prior to generation of a 3D object. In one example the type of build material stored in the build material store 806 is the same type as the build material used in the 3D printer that is to receive the prepared build unit 108.

In a further example, a build unit preparation module may combine the above-described functionalities and may be used to both form a set of build material layers on a build unit build platform and to preheat the build unit to a predetermined temperature. In another example, other types of build unit preparation processes may be performed by an appropriate build unit preparation module.

Referring now to FIG. 10, there is shown a schematic diagram of a 3D printing system 1000 according to an example. The system 1000 comprises one or multiple build unit preparation modules 1002, such as those described above, one or multiple build units 1004, and one or multiple 3D printers 1006. In the example illustrated in FIG. 10, a build unit transportation system 1008 is also provided. In another example, however, the build unit transport system 1008 may be omitted if the one or multiple build units 1004 are autonomously movable, as described earlier.

The system 1000 is controlled by a 3D printing management system 1010, shown in more detail in FIG. 11.

The 3D printing management system 1010 comprises a controller 1102, such as a microprocessor, and 3D printing system management instructions 1104 stored in a memory (not shown) that is coupled to the controller 1102. The management instructions 1104 are computer readable instructions that, when executed by the controller 1102, cause the controller to control different elements of the 3D printing system 1000 as described herein with reference to the flow diagram of FIG. 12.

At block 1200, the controller 1102 obtains 3D printer job schedule data. This data may, for example, describe a time schedule of the processing of a set of print jobs that are to be processed by the set of 3D printers 1006. Each print job may digitally define a set of objects that are to be generated by a 3D printer. The obtained schedule data may, for example, be provided by a 3D printing system print job management system (not shown), or it may be obtained directly from each 3D printer 1006. The obtained schedule data may, for example, indicate when a 3D printer 1006 is expected to start processing a 3D print job or it may indicate when a 3D printer 1006 is expecting to complete processing of a 3D print job.

At 1202, the controller 1102 controls a build unit 1004 to be moved into an appropriate build unit preparation module 1002 based on the obtained printer job schedule data. An appropriate build preparation module 1002 may be one that is not currently preparing a build unit. For example, if a 3D printer 1006 is currently processing a first print job the schedule data may indicate the time at which the 3D printer 1006 is to stop processing the first print job and the time at which the 3D printer 1006 is to start, or is available to start, processing a second subsequent print job. The controller 1102 may thus cause a build unit 1004 to be moved into a build unit preparation module 1002 at an appropriate time taking into account the time it takes to prepare a build unit. The time taken to prepare a build unit may depend on the type or types of preparatory processes that are to be performed on the build unit.

At block 1204, the controller 1102 controls the build unit preparation module 1002 to prepare a build unit 1004 to be used in the 3D printer 1006 by the time, or within a predetermined threshold of the time, the 3D printer 1004 has finished processing the print job.

At block 1206, the controller 1102 controls the build unit currently in the 3D printer 1006 to be removed therefrom, and then controls the newly prepared build unit to be moved into the 3D printer 1006.

The controller 1102 may then control the 3D printer 1006 to process a subsequent 3D print job using the newly prepared build unit.

In this way, the 3D printing system 1000 may be efficiently managed in way that helps maximize the productivity of 3D printers in the system.

It will be appreciated that example described herein can be realized in the form of hardware, software or a combination of hardware and software. Any such software may be stored in the form of volatile or non-volatile storage such as, for example, a storage device like a ROM, whether erasable or rewritable or not, or in the form of memory such as, for example, RAM, memory chips, device or integrated circuits or on an optically or magnetically readable medium such as, for example, a CD, DVD, magnetic disk or magnetic tape. It will be appreciated that the storage devices and storage media are examples of machine-readable storage that are suitable for storing a program or programs that, when executed, implement examples described herein. Accordingly, some examples provide a program comprising code for implementing a system or method as claimed in any preceding claim and a machine-readable storage storing such a program. Still further, some examples may be conveyed electronically via any medium such as a communication signal carried over a wired or wireless connection.

1. Apparatus to prepare a build unit for use in a three-dimensional printing system, comprising:
a build unit interface to receive or to couple to a build unit;
a build unit preparation element to perform at least one process to prepare the build unit for use in a three-dimensional printing system; and
a controller to:
control the build unit preparation module to perform the at least one process.

2. The apparatus of claim 1, further comprising:
an internal volume to wholly receive the build unit; and
a heating element to heat at least a portion of the build unit, and
wherein the controller is to control the heating element to heat at least the portion of the build unit to a predetermined temperature.

3. The apparatus of claim 2, wherein the controller is to obtain a characteristic of a 3D printer that is to use the build unit, and is to control the heating element to heat at least the portion of the build unit to a predetermined temperature based on the obtained characteristic.

4. The apparatus of claim 3, wherein the controller is to obtain a characteristic relating to one or more of: a type of 3D printer with which the build unit is to be used; and a type of build material to be used by the 3D printer.

5. The apparatus of claim 1, wherein the controller is to obtain data indicating when a 3D printer is to use the prepared build unit and to prepare the build unit at a time based on the data.

6. The apparatus of claim 1, further comprising: an interface to couple to a heating element of the build unit and wherein the controller is to control a heating element of the build unit to heat the build unit to a predetermined temperature.

7. The apparatus of claim 1, further comprising:
an internal volume to wholly receive the build unit; and
a layering device to form a layer of build material on a build platform of the build unit;
a container to contain a supply of build material; and
wherein the controller is to control the layering device to form a set of layers of build material on the build unit build platform.

8. The apparatus of claim 1, wherein the apparatus is separate from a 3D printer.

9. A method of preparing a build unit for use in a 3D printer comprising:
receiving a build unit at an interface of a build unit preparation module; and
performing a predetermined build unit preparation process on the build unit.

10. The method of claim 9, wherein the build unit preparation process comprises one or more of: heating at least a portion of the build unit to a predetermined temperature; and forming a set of layers of build material on a build platform of the build unit.

11. The method of claim 9, further comprising:
determining a time when the build unit is to be used by a 3D printer, and completing the preparation process based on the determined time.

12. A three-dimensional system management system comprising:
a processor;
a memory coupled to the processor; and
processor executable instructions stored on the memory and executable by the processor to:
obtain 3D printer job schedule data;
cause a build unit to move into a build unit preparation module;
control the build unit preparation module to prepare the build unit for use in a 3D printer; and
move the prepared build unit into the 3D printer.

13. The system of claim 12, wherein the instructions further comprise instructions to:
control the build unit preparation module to one or more of: heat at least a portion of the build unit to a predetermined temperature; and form a set of layers of build material on a build platform of the build unit.

14. The system of claim 12, wherein the instructions further comprise instructions to prepare the build unit at a time determined by the obtained schedule data.

15. The system of claim 12, wherein the instructions further comprise instructions to move the prepared build unit via a build unit transport system.
